(19) United States
(12) Patent Application Publication
(10) Pub. No.: US 2018/0293581 A1
(43) Pub. Date: Oct. 11, 2018

(54) System and Method for a Dynamic Set of Validation Check-Points in Real Property Transactions Based on Score Parsing

(71) Applicant: Reobe, Inc., San Jose, CA (US)

(72) Inventor: Amit Bansal, San Jose, CA (US)

(21) Appl. No.: 15/483,919

(22) Filed: Apr. 10, 2017

(51) Int. Cl. G06Q 20/40; G06Q 50/16; G06Q 20/02

(52) U.S. Cl. CPC G06Q 20/4016; G06Q 20/02; G06Q 20/405; G06Q 50/16

(57) ABSTRACT

Automated valuation model and various prior art incorporate a mathematical model with data sets for standardizing a valuation for real property for various applications. The invention described in the application generally describes systems and methods for validating real property transactions. More particularly, and without any limitations, embodiments of the present disclosure relate to a dynamic and reconfigurable set of check-points for a real property transaction based on a score generation and parsing. Furthermore, the present disclosure relates to matching, tagging and payment of the listed property between the purchasers and listers, with the aid of a list engine and purchase engine, over a network.

### BACKGROUND

### Technical Field

The technical field generally describes systems and methods for validating real property transactions. More particularly, and without any limitations, embodiments of the present disclosure relate to a dynamic and reconfigurable set of check-points for a real property transaction based on a score generation and parsing. Furthermore, the present disclosure relates to matching, tagging and payment of the listed property between the purchasers and listers, with the aid of a list engine and purchase engine, over a network.

### Background of Related Art

The prior art is replete with references that disclose a system and, or method for standardizing a valuation for real property for various applications. One such method is the automated valuation model (AVM), which incorporates a mathematical model with data sets. This model has become the industry standard—and has been implemented in a wide array of real estate segments, from appraisals, auctions, investments, mortgage lending, brokerage listings, etc. The model, in general, calculates a property's value at a specific point in time by analyzing comparable properties. The AVM's calculations are largely based on pre-defined, inflexible, geographical data sets. It is not elastic enough to adapt based on ever-changing data sets. As a result, the computed score or value is not a true real-time reflection of value, and is invariably including a time-lag. Even the more elastic variables, such as historic house price movements and home improvements, do not go far enough in elasticizing the other static variables.

What's more, the AVM, while property specific, does not consider the individual key attributes of a specific user or specific prospective lister/purchaser (l/p). In other words, computed scores do not consider weighting of the individual key attributes of a specific l/p. For instance, if a specific purchaser (p) is middle-aged; drives a mini-van; and has several school-attending children, the historical performance of the school district and school-heavy property taxes should be considered key indicators, and thus, weighted heavier. Furthermore, attributes of p, such as, number of night-life venues within a defined radius or access to mass transportation should be conversely weighted. The AVM—and all its various other valuation tools—lack this weighting feature, and thus, lack a real-time and nuanced vision of the true assessment of a property, transaction, and, or p/l. Generating such a real-time and nuanced assessment from parsed p/l profiles would go a far way in fostering the sorely-needed confidence and trust in facilitating real property transactions.

Furthermore, no validation tool exists within a real property transaction model that is dynamically driven by a p/l-dependent profile score—parsed for weighted key indicators. As such, any extant validation tool within the sphere of real property transactions is static and not elastic to adapt to the ever-changing realities of the people involved in such a transaction. The extant tools are simply a reflection of the service provider's best practices and, or industry standards. Furthermore, if there are moving variables, such variables are relegated to the property itself—perhaps covering limited socio-geographic attributes—but do not in any way encompass the full breadth of relevant personal attributes and their potential swings during one's life. Even such models that do incorporate these varying property and, or limited socio-geographic attributes, do not affect any changes to the static qualifying validation check-points. Again, for a p/l, trust and confidence remains elusive. As the nature of commerce has been redefined in our increasingly interconnected world, trust and confidence has become even more critical. As we move away from a hierarchical, service-driven mode of commerce, to a more distributive, flattened, peer-driven mode of commerce, valuation models that can reaffirm trust and confidence will be of the utmost priority. Trust and confidence that is derived from deep analytics of a plurality of dynamic personal attributes—in addition to the standard property/socio-geographic attributes—will serve as the backbone of this new peer-driven commerce.

Peer-to-peer (P2P) computing or networking is a distributed application architecture that partitions tasks or workloads between peers. Peers are equally privileged, equipotent participants in the application. They are said to form a peer-to-peer network of nodes. Peers make a portion of their resources, such as processing power, disk storage or network bandwidth, directly available to other network participants, without the need for central coordination by servers or stable hosts. Peers are both suppliers and consumers of resources, in contrast to the traditional client-server model in which the consumption and supply of resources is divided. Emerging collaborative P2P systems are going beyond the era of peers doing similar things while sharing resources, and are looking for diverse peers that can bring in unique resources and capabilities to a virtual community thereby empowering it to engage in greater tasks beyond those that can be accomplished by individual peers.

A peer-to-peer network architecture is designed around the fact that equal peer nodes simultaneously functioning as both “client” and “servers” to the other nodes on the network. This model of network arrangement differs from the client-server model where communication is usually to and from a central server. A typical example of a file transfer that uses the client-server model is the File Transfer Protocol (FTP) service in which the client and server programs are distinct: the clients initiate the transfer, and the servers satisfy these requests.

The architecture of the systems we work on today is often much more efficient, flexible and scalable than the consulting models we use to implement those systems. Systems have been developed to connect consumers and their industry service providers over the Internet and the World Wide Web. Some systems use any one of, or a combination of, e-mail messaging, text messaging, video messaging and or web-based forms to increase the level of connectivity between a consumer and his assigned service provider. The consumer sends an e-mail, text, MMS, video message or goes directly to a website that generates an e-form and sends a message usually, an e-mail, text or an e-mail type message to a local service provider, thus creating a contact between the two parties. This system provides an additional spectrum of services to the consumer, though the benefits of such services is not clear. One of the major concerns associated with these additional spectrum of services, is that it may result in an over consumption of services, rather than provide a better co-ordination between the consumer and independent service provider. Various other on-demand service arrangements systems also exist that arrange for delivering services to be provided by the independent service providers, unfortunately, fail to eliminate third party involvement.

The clients are interested in the independent consultants because they offer them with expert advice, something that gives them better efficiency, sales and returns. However, one thing that keeps happening in peer-to-peer service arrangements systems is the lack of trustworthiness, not to mention guarantees of secure financial transactions and payments. Additionally, the consultants are devoid of expertise in other ancillary business segments, such as accounting, marketing, and legal issues.

As the prior art suggests, the lack of trustworthiness in P2P or peer-driven arrangements is since the only seal of trust comes in the form of user ratings. User ratings are wrought with limitations, namely, they are a peer-generated or system-generated score of transaction compliance. At most, they vouch for the fact that a user hasn't been in flagrant breach of a transaction obligation. However, they do not address profile-fed key positive or negative indicators of a user's character. What's more, there are several character nuances that are not captured by a simple peer-generated or system-generated user rating.

As peer-to-peer transactions expand into our collective consciousness—and all segments of our consuming behavior—shoring up trustworthiness becomes increasingly critical. Going beyond a superficial user rating system—relying on a more nuanced matching of user attributes from parsed user profiles—will be necessary to reaffirm the much-needed trust in the era of the peer-driven transaction. Real property transactions performed in a peer-driven fashion are no exception. In fact, real property P2P transactions, given the overwhelming size of the ticket, require even more trust, confidence, and validation. This trust, confidence, and validation are discernibly void in the real property transaction tools market and prior art.

### SUMMARY

Considering the above, it is readily apparent that a need exists in the art for a real property transaction platform that matches p/l along a plurality of weighted profile attributes. Moreover, once matched, facilitates the transaction by, among other things, reconfiguring a set of validation check-points based on finely parsed scores generated from the plurality of weighted profile attributes. As a result, the validation is dynamic and tailored to the ever-evolving traits of a p/l. It is not a static, one-size-fits all approach, and as a result, delivers the sorely needed trust, confidence, and validation in peer-driven real property transactions.

It is therefore a primary object of the invention to provide a marketplace for real property transaction services that allows p/l to seek trust, confidence, and validation in real property transactions. In one aspect, disclosed is a system for generating a dynamic set of validation check-points for real property transactions based on a parsed score, comprising: a list engine, wherein the list engine comprises at least one of a listing, lister profile, listing criteria, and a lister payment agent; a purchase engine, wherein said purchase engine comprises at least one of a purchaser profile, purchasing criteria, and a purchaser payment agent. Furthermore, disclosed system further comprises a weight index generator; a confidence score generator; a validation matrix; a processor; a storage element coupled to the processor; encoded instructions; wherein the system is configured to: (1) assign a learned weight score to at least one individual criteria from at least one of a matched listed property, matched lister profile, and, or matched purchaser profile from any one of the list engine and, or purchase engine by the weight index generator; (2) apply a learned raw score as a function for each weighted individual criteria to generate a weighted criteria score for each individual criteria, and aggregating said criteria scores to generate a confidence score for each impending transaction by the confidence score generator; and finally (3) parse a threshold-above confidence score for each impending transaction for threshold-above weighted criteria score and any one of a threshold-above raw score indicating a positive key performance indicator (KPI) and, or a threshold-below weighted criteria score and any one of a threshold-above raw score indicating a negative KPI by the validation matrix, and wherein the validation matrix suggests any number or any type of validation check-points for each impending transaction based on at least one of the threshold-grade: confidence score, positive KPI, and, or negative KPI.

It is another object of the invention for the system to facilitate trust, confidence, and validation in a peer-driven real property transaction by matching p/l based on a plurality of personal/property/socio-geographical profile attributes. In one aspect, disclosed is a system comprising: a list engine, wherein the list engine comprises a plurality of listings, lister profiles and a lister payment agent; a purchase engine, wherein the purchase engine comprises a plurality of purchaser profiles, purchasing criteria, and a purchaser payment agent. Furthermore, the system may comprise a matching module; a payment module; a processor; a storage element coupled to the processor; encoded instructions; wherein the system is configured to: (1) tag any one of, or combination of, personal/property/socio-geographic attributes from a list, lister profile, purchaser criteria, and purchaser profile; (2) match a purchaser to a lister by a matching module applying a matching rule, wherein said match, correlates at least one tagged attribute from the list and lister profile to a tagged attribute from the purchaser criteria and purchaser profile; (3) match purchaser and lister with a highest matching score as per the matching rule; and finally (4) wherein a confirmation of validation triggers transfer of at least a partial contract amount from a purchaser payment agent into the lister payment agent by the payment module.

In a further object of the invention, a confirmation of validation triggering the transfer of at least a partial contract amount by the payment module is only upon a complete check-off the reconfigurable set of validation check points based on the generated scores—parsed by learned, weighted scores and learned raw values. Learning may be done based on any one of machine learning, fuzzy techniques, neural network techniques, and any other probabilistic methods.

Further yet, in another object of the invention, once a contract between the purchaser and lister is fully validated; signed and finalized; a trigger by a payment module, transfers at least a partial amount of the contract amount into an intermediary account, which upon satisfaction of a contract obligation based on a verification agent causes disbursal of at least a partial amount of the contract amount from the intermediary account to a provider account. The purchaser may engage in a random, scheduled, or automated fashion into a 3^{rd}-party intermediary account, whereby disbursal of funds from the 3^{rd}-party intermediary account to the purchaser is only performed upon the triggering of a complete check-off of the dynamic validation check-points. Furthermore, the p/l may be provided with various ancillary real property transaction services, such as, legal, insurance, inspections, etc. The utility of the present invention may be illustrative across various industries, where trust, confidence, and validation across a peer-driven platform is required by a purchaser and lister in a big ticket commercial transaction.

The details of one or more embodiments are set forth in the accompanying drawings and description below. Other features, objects, and advantages of the subject matter will be apparent from the description and drawings, and from the claims.

### BRIEF DESCRIPTION OF THE DRAWINGS

The drawings illustrate the design and utility of embodiments of the present invention, in which similar elements are referred to by common reference numerals. To better appreciate the advantages and objects of the embodiments of the present invention, reference should be made to the accompanying drawings that illustrate these embodiments. However, the drawings depict only some embodiments of the invention, and should not be taken as limiting its scope. With this caveat, embodiments of the invention will be described and explained with additional specificity and detail using the accompanying drawings in which:

FIG. 1 is a system diagram according to an aspect of the invention.

FIG. 2 is a process flow diagram of the universal property management system according to an aspect of the invention.

FIG. 3 is a system diagram of the network system according to an aspect of the invention.

FIG. 4 is a block diagram according to an aspect of the invention.

FIG. 5 is a method flow diagram according to an aspect of the invention.

FIG. 6 shows an exemplary transaction score block diagram according to an aspect of the invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

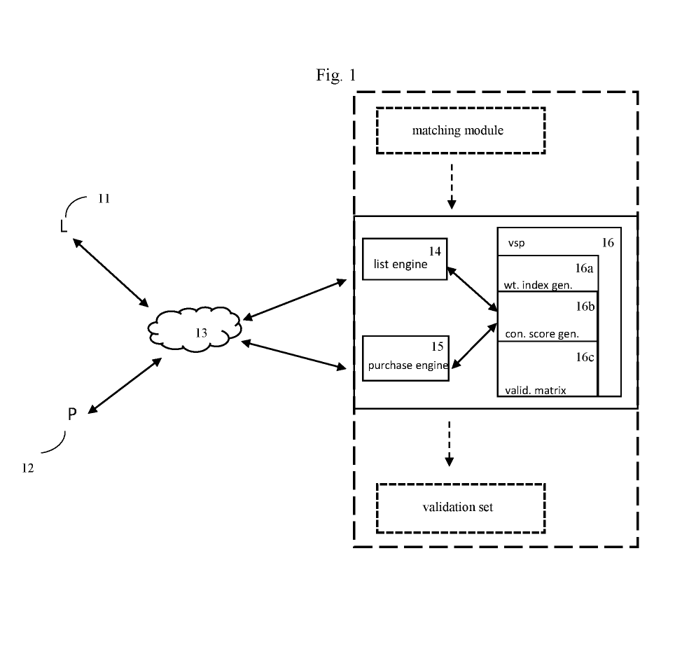

FIG. 1 is a system diagram illustrating a high-level network architecture in accordance with an aspect of the invention. In a preferred embodiment, the validation based on score parsing (vsp) engine 16 may be communicatively coupled to the lister of real property 11 and purchaser of real property 12 via a network 13. The list engine 14 and purchase engine 15 may be configured to construct a profile based on at least one data-mined behavioral criteria beyond user-entered information. In such an embodiment, data mining or crawling may be based on a de minimums data extraction related to a basic social or demographic characteristics from a social media site, for instance. Alternatively, profile construction by the list engine 14 or purchase engine 15 may be performed based on user-entered information, historical market data, and, or real-time data. User-entered information may be in the form of volunteered information and, or prompted answers.

As illustrated in FIG. 1, the list engine 14 and purchase engine 15 may be a data storage that is configured to store text or archived videos/images. The data may relate to at least one of a lister profiles, listings, listings criteria, lister payment agent, purchaser profiles, purchaser criteria, and a purchaser payment agent. The data may be stored in any suitable formats as known in the art and saved in a singular and, or a plurality of local databases or remote databases. Furthermore, the databases may be centralized, distributed, and, or be based on a cloud-based scheme.

Also, shown in FIG. 1, the network 13 may be any suitable wired network, wireless network, a combination of these or any other conventional network, without limiting the scope of the present invention. Few examples may include a LAN or wireless LAN connection, an Internet connection, a point-to-point connection, or other network connection and combinations thereof. The network 13 may be any other type of network 13 that can transmit or receiving data to/from host computers, personal devices, telephones, video/image capturing devices, video/image servers, or any other electronic devices. Further, the network 13 can transmitting/send data between the mentioned devices. Additionally, the network 13 may be a local, regional, or global communication network, for example, an enterprise telecommunication network, the Internet, a global mobile communication network, or any combination of similar networks. The network 13 may be a combination of an enterprise network (or the Internet) and a cellular network, in which case, suitable systems and methods are employed to seamlessly communicate between the two networks.

In continuing reference to FIG. 1, the system includes a vsp 16, connected to a lister 11 and purchaser 12 via a communications network 13. In a preferred embodiment, disclosed is a system for generating a dynamic set of validation check-points for real property transactions based on a parsed score, the system comprising: a list engine, wherein the list engine comprises at least one of a listing, lister profile, listing criteria, and a lister payment agent; a purchase engine, wherein the purchase engine comprises at least one of a purchaser profile, purchasing criteria, and a purchaser payment agent.

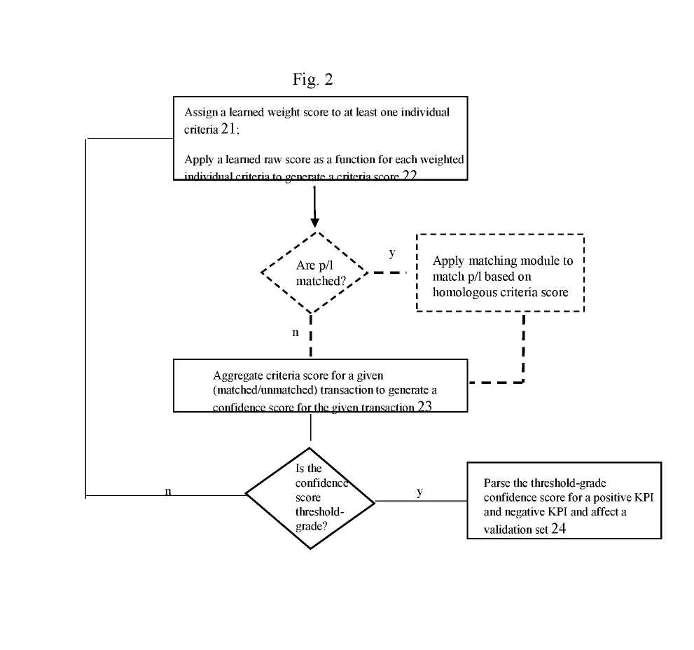

As FIG. 2 (process flow diagram of the vsp) illustrates, the system may further include a weight index generator; a confidence score generator; a validation matrix; a processor; a storage element coupled to the processor; encoded instructions; wherein the system is configured to: first (1) assign a learned weight score to at least one individual criteria from at least one of a matched listed property, matched lister profile, and, or matched purchaser profile from any one of the list engine and, or purchase engine by the weight index generator 21; next (2) apply a learned raw score as a function for each weighted individual criteria to generate a weighted criteria score for each individual criteria 22; next (3), aggregating the criteria scores to generate a confidence score for each impending transaction by the confidence score generator 23; then (4) parse a threshold-above confidence score for each impending transaction for threshold-above weighted criteria score and any one of a threshold-above raw score indicating a positive key performance indicator (KPI) and, or a threshold-below raw score indicating a negative KPI by the validation matrix 24; and finally (5) wherein said validation matrix suggests any number or any type of validation check-points for each impending transaction based on at least one of the threshold-grade confidence score, positive KPI, and, or negative KPI 25.

In some embodiments, the learned criteria scoring and, or learned raw scoring may be updated based on any one of a probabilistic learning techniques, such as, neural networks, fuzzy networks, etc. Score value calibrations may also be defined by an administrator. Score value calibrations may also be based on historical data and, or updated market data. In another embodiment of the present invention, a scoring algorithm may employ an unsupervised machine learning to learn the reference scoring features from representative attributes. Examples of the one or more representative attributes may be, but are not limited to, lot size, square footage, location, profession, family size, marital status, and other personalized profile features. The criteria and raw scoring algorithm may be executed on top of a profile classification algorithm (segregating personal attributes from property listing attributes and socio-geographic attributes)—allowing the system to localize the referencing region, thus decreasing the amount of computation. This layering approach results in reducing power consumption and/or increase the score assigning speed and accuracy. The archiving of attribute and score values for each list and purchase profile in the weight index generator 16b allows for quick retrieval and referencing for confidence score generating (confidence score generator 16b) for a new transaction.

In preferred embodiments, the validation matrix 16c will parse only threshold grade confidence scores to effectuate a change in the validation check-points. The parsing includes extreme weighted personalized attributes with high raw score values. This provides a personalized context to a confidence score and accordingly adjust a dynamic set of validation check-points by the validation matrix 16c. As a result, trust, confidence, and validation is also provided on the back-end of a real property transaction. Alternatively, the validation matrix 16c will parse even non-threshold grade confidence scores for effectuating a change to the validation check-list.

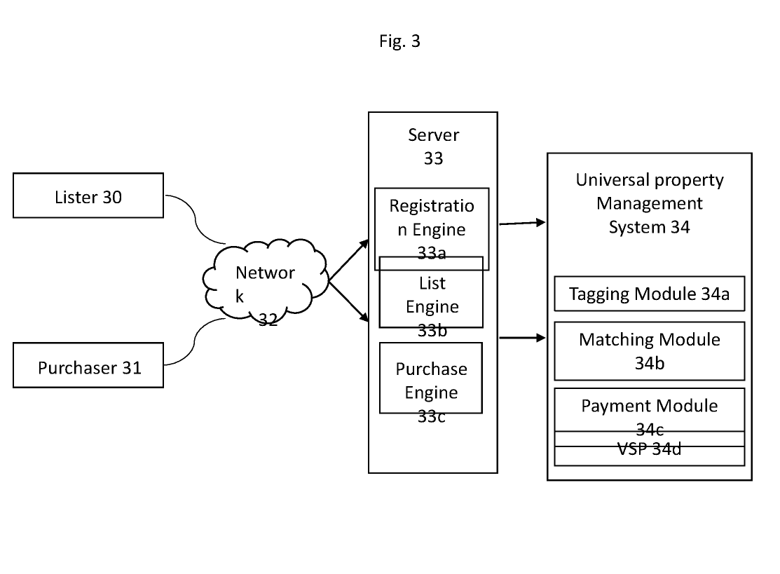

In some embodiments, scoring and validating by the vsp 16 occurs only of matched listers and purchasers by a matching module (FIG. 3), based on shared tagged attributes. The weight index generator 16a of the vsp 16 may also tag a weight criteria score to personalized profile attributes for the intention of matching a purchaser to a lister. As such, trust, confidence, and validation may be delivered at the very beginning of the transaction process. In other embodiments, the vsp 16 may parse confidence scores for extreme weighted attributes from any selected pair of purchaser and lister.

In yet other embodiments, the [matched and] validated lister and purchaser will trigger a payment module, which transfers at least a partial amount of the contract amount into an intermediary account, which upon satisfaction of a contract obligation based on a verification agent causes disbursal of at least a partial amount of the contract amount from the intermediary account to a lister account. Alternatively, the satisfaction of the validation check-points and other contract obligations will trigger at least a partial transfer of funds directly from a purchaser to a lister.

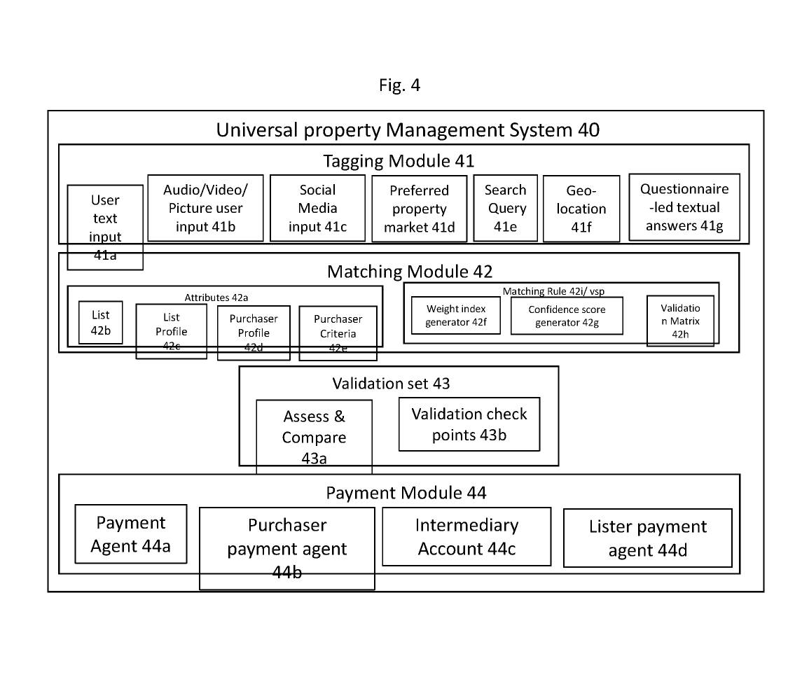

FIGS. 3 and 4 are system diagrams according to an aspect of the invention. In an embodiment of the invention, a universal property management system 34, 40 for generating a dynamic set of validation check-points 43b for real property transactions based on a parsed score, comprises a processor, a storage element coupled to the processor, encoded instructions, wherein the system is configured to (1) assign a learned weight score to at least one individual criteria; (2) apply a learned score as a function for each weighted individual criteria to generate a criteria score by a weight index generator 42f; (3) match a purchaser 31/lister 30 based on the homologous criteria score via the matching module 34b, 42; (4) aggregate the criteria score to generate a confidence score by a confidence score generator 42g for a given transaction; (5) parse a threshold-above confidence score for each impending transaction for any one of a positive indicator and, or negative indicator by the validation matrix 42h; and further cause the set of validation checkpoints to adapt, reflecting at least one of the positive indicator and, or negative indicator parsed from the threshold-above confidence score.

In a preferred embodiment of the invention, a universal property management system 34 comprises a lister 30, purchaser 31 connected via a network 32 to the server 33. The server 33 further comprises of a registration engine 33a, a list engine 33b and a purchase engine 33c. The universal property management system 34, 40 further comprises of a profile module that creates any one of the list 42b, lister profile 42c, purchasing criteria 42e, and the purchaser profile 42d based on a user input, further comprising of any one of a questionnaire-led text input 41g, user-volunteered text input 41a, audio/video input 41b, photograph input, social-media feed 41c, search query 41e, scrolled items, clicked items, home address, geo-location 41f, place of origin, other owned properties, preferred real property market and, or other real property references 41d. In an embodiment, the purchaser 31 may create a user profile based on the requirements of the users living in the property.

Further yet, the universal property management system 34, 40 further comprises of a tagging module 34a, 41 which, tags attributes from any one of the list engine 33b and, or purchase engine 33c that correlate with attributes listed in a pre-defined and, or intelligently updated library of attributes. The tagging module 34a tags attributes from any one of, but not limited to, the list engine 33b and, or purchase engine 33c based on a tagging rule, wherein the rule tags attributes based on a threshold-dependent textual or word proximity of any pre-defined social, economic, location, place of origin, other owned properties, preferred real property market and, or other real property references.

Further yet in an embodiment of the present invention, the universal property management system 33, 40 is comprised of a matching module 34b,42 wherein the matching module 34b, 42, tags any one of, or combination of, a listing 42b, attributes 42a, lister profile 42c, purchaser criteria 42e, and purchaser profile 42d; matches a purchaser 31 to a lister 30 by a matching module 34b,42 applying a matching rule 42i, wherein said match, correlates at least one tagged attribute from the list 42b and lister profile 42c to a tagged attribute from the purchaser criteria 42e and purchaser profile 42d; and match purchaser 31 and lister 30 with a highest matching score as per the matching rule 42i by the vsp engine 34d. Further yet, the matching rule score is based on, assigning a learned weight score to at least one individual criteria from at least one of a list 42b, lister profile 42c, purchaser criteria 42e and, or purchaser profile 42d from any one of the list engine 33b and, or purchase engine 33c by the weight index generator 42f. Further yet, in another embodiment of the invention, once the p/l are matched, a learned raw score as a function for each weighted individual criteria is applied to generate a weighted criteria score for each individual criteria and finally, the criteria scores are aggregated to generate a confidence score for each impending transaction by the confidence score generator 42g.

Further yet, following the generation of a confidence score, parsing a threshold-above confidence score is performed indicating a positive KPI and a threshold-below confidence score indicating a negative KPI for each impeding transaction by the validation matrix 42h in the vsp 34d. In a continuing embodiment of the invention, the validation matrix 42h suggests any number or any type of validation checkpoints 43b based on at least one of, a threshold-grade confidence score, a negative KPI or a positive KPI. Further yet, in an embodiment of the invention, the validation check-points 43b are at least one of, but not limited to, listing pictures, clean title and documents, property inspection, financial background and status of the purchaser/lister, amenities, cost of living, crime rate, education, employment opportunities, age of property, builder reputation, builder reviews, weather, current and historical market value of property, accessibility and proximity of amenities and public transport, retirement facilities and, or median income based on area. Further yet, the validation set 43 assess and compares 43a the real property listed by the lister 30 for purchase.

Further yet, in an embodiment of the invention, a universal property management system 34, 40 further comprises of a validation set 43, wherein a validation pathway depending on any one of, threshold-grade confidence score, positive KPI or negative KPI defines a validation checkpoint 43b to be any one of, neutrally weighed, completely bypassed, rigorously scrutinized, negligently scrutinized, or manually included. For example, consider a scenario, where two purchasers of real property, Purchaser X, a 60-year-old couple in City A with a negative KPI for an education validation checkpoint and a Purchaser Y, a 35-year-old couple with school going children in City B with a positive KPI for an education validation check point have an identical confidence score. Based on, the validation pathway, the system may completely bypass the education checkpoint for Purchaser X whereas, the system may rigorously scrutinize the validation checkpoint for education for Purchaser Y. Alternatively, if the Purchaser X's grandkids happen to live with them, the user can manually include a validation checkpoint for further routinization. In another alternate scenario, if the Purchaser Y's kids are home schooled, the user can manually enter to completely bypass a validation check point for further routinization.

Further yet, in an embodiment of the invention, the matching modules 34b, 42 matches the lister 30 with the purchaser 31 based on a pre-qualification determination of financing of the purchaser 31. Alternatively, the matching module 34b, 42 may match the lister 30 with the purchaser 31 based on the ratings and reviews of the lister 30. In yet another embodiment, the matching module 34b, 42 matches a plurality of purchasers 31 with a lister 30 based on a ranking of a highest confidence score.

In a continuing reference, the universal property management system 34, 40 further comprises of a payment module 34c, 44. Following a completion of the validation pathway and an agreement between the lister 30 and purchaser 31 on the price of the real property, the payment module 34c, 44 triggers transfer of at least a partial amount of the contract amount into an intermediary account 44c by the payment module 34c, 44, wherein satisfaction of a contract obligation based on a verification agent causes disbursal of at least a partial amount of the contract amount from the intermediary account 44c to a lister account. Further yet, in a continuing embodiment of the invention, a confirmation of purchase triggers transfer of at least a partial contract amount from a purchaser payment agent 44a into the lister payment agent 44d by a payment module 34c, 44. Additionally, the transfer of the at least partial contract amount from a purchaser payment agent 44a into the lister payment agent 44d is intervened by an intermediary account 44c. In another embodiment, at least partial contract amount is disbursed from the intermediary account 44c upon a validation and, or fulfillment event. Additionally, a dissatisfaction of a contract obligation based on a verification agent freezes the disbursal of the contract amount from the intermediary account 44c to the lister account.

In yet other embodiments, the payment module 34c, 44 may simply be coupled to a bank account of the purchaser 31, wherein funds are drawn from the purchasers 31 bank account and subsequently transferred to the bank account of the lister 30 by the payment module 34c, 44. Just as in the case of the intermediary account 44c, payments from the purchaser 31 account may be disbursed in partial amounts or in a full amount to the lister 30 account by the payment module 34c, 44.

In another embodiment of the invention, the universal property management system 34, 40 may further comprise of a rating system wherein, the rating system rates any one of, but not limited to a user based on at least one of a time of completion, quality of property review, and, or number of transactions. Alternatively, the matching module 34b, 42 may give a highest weighted average to a user rating of any one of the purchaser 31 and the lister 30. Additionally, the universal property management system 34, 40 may further comprise delivery, over a network, of at least one of, but not limited to, inspection of property, renovation management of property, financial services, including securing bank loans, ancillary legal services, including securing of the title and, or closing escrow upon the satisfaction of the dynamic set of validation checkpoints and contract obligations. In yet another embodiment, the system 34, 40 may provide credit checks of the lister 30 and purchaser 31 for an in-depth analysis.

In other alternative embodiments, the universal property management system 34, 40 may include an auction module (not shown), which may allow a plurality of matched purchasers 31 the ability to bid or secretly bid for the real property listed by the lister 30. The auction module may have the effect of placing upward pressure on property price, thus, benefiting the lister 30.

Still referring to FIGS. 3 and 4, in an alternative embodiment, the universal property management system 34, 40 may be configured to perform match based on matching rules from a purchaser profile for a customized and individualized experience, matching a purchaser profile against a plurality of tagged lister profiles to determine the highest scored match between lister and purchaser in a threshold-dependent manner by a matching module. In addition to matching lister with a purchaser along user-created criteria (location, time, activity preference, etc.). In an alternative embodiment, the matching module may match a purchaser to a lister, wherein the match, correlates terms from a purchase request to a tagged attribute from a lister profile by a tagging module. Based on a matching rule, generate a matching score based on a number of, or a degree of correlations. The purchaser is then matched with a lister, based on the matching score. Further, alternative embodiments may include a match process that does not entail a scoring scheme or threshold-dependency, but rather, just simple keyword matching between purchase query and purchasers profile tags—tagged by the tagging module.

While also not illustrated in FIGS. 3 and 4, in yet another alternative embodiment of the invention, the system architecture may comprise three major logical layers: storage, query/analysis, and the application layer. The data storage layer consists of any one of either a non-relational, relational, ontology, cloud storage, and/or 3rd party databases. Data sets may communicate with different storage layers depending on the type of captured data. Data points may be crawled for or keyword searched for and curated depending on the type of data/format it is and tagged by data attachment index, tag mapping, and block mappings by the tagging module order for it to be retrieved quickly by the mapping module. The query and analysis layer consists of the workflow engine and ontology engine. The former is involved in the scheduling and execution of workflows and processes. The latter is involved in the annotation of data sets and providing the semantic substrate to manipulate the various formats of data sources into a single, standardized format. Moreover, it is the ontology engine within the profile module that enables integration and aggregation of different data formats to populate the respective fields of the respective profile. The profile module with conditional triggers, perform specific actions when conditions are satisfied. For example, when data satisfies a user profile field, the ontology engine and profile module facilitate the transfer of the designated data for specific user profile field population. The matching module performs a keyword search query against a plurality of lister profiles with a compatible purchaser requestor based on matched search criteria and matched user profiles. Matching in some embodiments encompass using a scoring matrix of aligned interests and a scoring-threshold dependency. Other embodiments involving the matching module may not involve a scoring matrix or a scoring-threshold, but alternatively, just a threshold of several aligned social interests. Finally, the application layer consists of components that are involved in the management, access, and distribution of the data. An API service component may offer an easy-to-use interface for access, management, visualization of third-party data, such as Google Maps, social media sites, micro payment sites, etc.

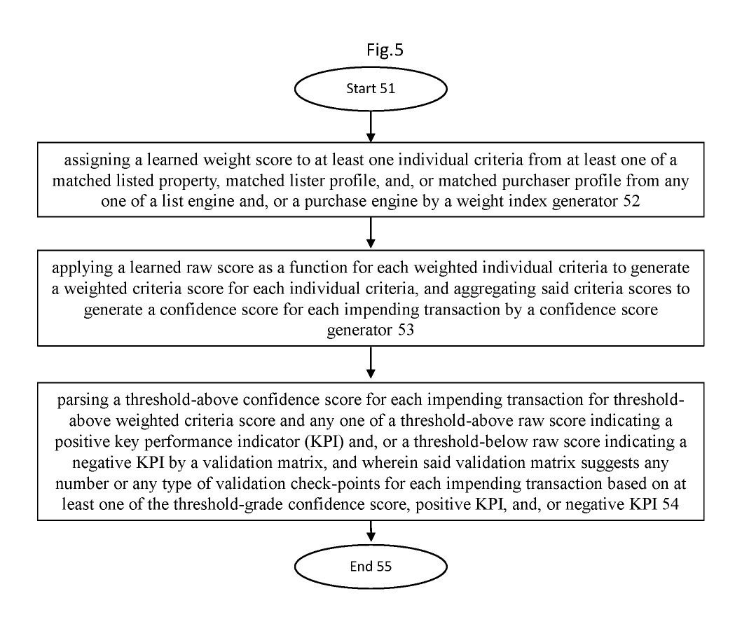

FIG. 5, is a method flow diagram according to an aspect of the invention. In an exemplary embodiment of the invention, a method for generating a dynamic set of validation check-points for real property transactions, said method comprising the steps of: (1) assigning a learned weight score to at least one individual criteria from at least one of a matched listed property, matched lister profile, and, or matched purchaser profile from any one of a list engine and, or a purchase engine by a weight index generator; (2) applying a learned raw score as a function for each weighted individual criteria to generate a weighted criteria score for each individual criteria, and aggregating said criteria scores to generate a confidence score for each impending transaction by a confidence score generator; and (3) parsing a threshold-above confidence score for each impending transaction for threshold-above weighted criteria score and any one of a threshold-above raw score indicating a positive key performance indicator (KPI) and, or a threshold-below raw score indicating a negative KPI by a validation matrix, and wherein said validation matrix suggests any number or any type of validation check-points for each impending transaction based on at least one of the threshold-grade confidence score, positive KPI, and, or negative KPI.

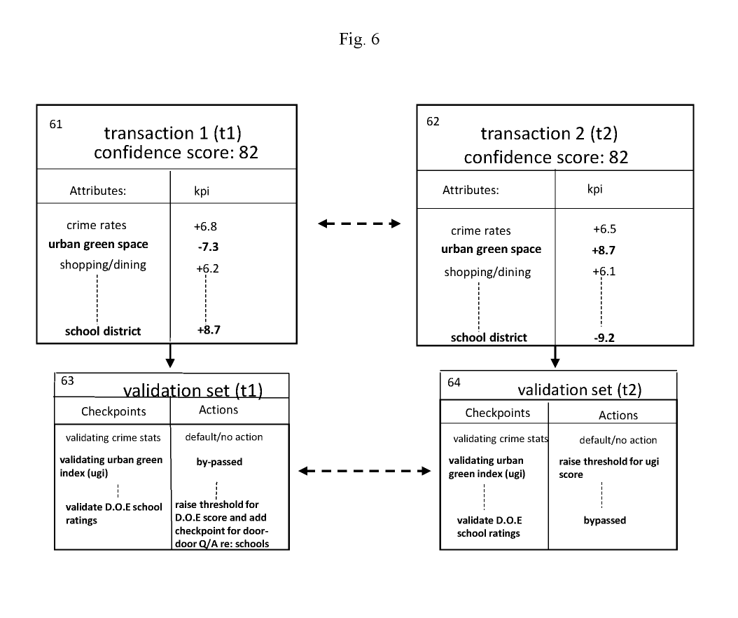

FIG. 6 shows a block diagram of the validation pathway according to an aspect of the invention. Consider a scenario, where the transaction confidence score 62 for both transactions 1 61 and 2 62 is equal to be of 82 for the same attributes, but each transaction confidence score have varied KPI values. The attributes considered for this example are crime rates in a neighborhood, amount of urban green space, shopping/dining and school district. Further yet, depending on a positive, negative KPI value, a validation checkpoint is triggered. For example, in transaction 1 61, the school district has a positive KPI value of +8.7 indicating an above threshold value hence, in the validation set 63 for transaction 1 61, school ratings from the Department of Education (D.O.E) validation check point is added by raising a threshold for D.O.E score and further adding a checkpoint for a door-door Question/Answer session with potential neighbors regarding schools. Similarly, the urban green space requirement in transaction 1 61 has a negative KPI of −7.3, hence, in the validation set 63 for transaction 1, validating the urban green space (ugi) is by-passed. Further yet, consider another scenario, as seen in transaction 2 62, the transaction confidence score is 82. But the KPI values for the same attributes considered in transaction 1 61 is unalike. The KPI score for ugi is +8.7, hence in the validation set 64, validating ugi has a raised threshold and the school district has a negative KPI score of −92, hence the validation check point in the validation set 2 64 is completely bypassed. Further yet, the crime rates and shopping/dining attributes in both the transactions 1 61 and 2 62 have a threshold-grade KPI values, hence the validation checkpoints are neutral devoid of any further action.

Further yet, multiple number of transactions may be deployed at a time having an identical confidence and the attributes considered for each transaction may vary. Additionally, the system may trigger at least one of, but not limited to, validation check-points comprising of, listing pictures, clean title and documents, property inspection, financial background and status of the purchaser/lister, amenities, cost of living, crime rate, education, employment opportunities, age of property, green space, builder reputation, builder reviews, weather, current and historical market value of property, accessibility and proximity of amenities and public transport, retirement facilities and median income based on area.

While this specification contains many specific execution details, these should not be interpreted as limitations on the scope of any inventions or of what may be claimed, but rather as descriptions of features specific to particular embodiments of particular inventions. Certain features that are described in this specification in the context of separate embodiments can also be implemented in combination in a single embodiment. Contrariwise, various features that are described in the context of a single embodiment can also be implemented and interpreted in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

We claim:

1. A system for generating a dynamic set of validation check-points for real property transactions based on a parsed score, said system comprising:
a list engine, wherein said list engine comprises at least one of a listing, lister profile, listing criteria, and a lister payment agent;
a purchase engine, wherein said purchase engine comprises at least one of a purchaser profile, purchasing criteria, and a purchaser payment agent;
a weight index generator;
a confidence score generator;
a validation matrix;
a processor;
a storage element coupled to the processor;
encoded instructions;
wherein the system is configured to:
assign a learned weight score to at least one individual criteria from at least one of a matched listed property, matched lister profile, and, or matched purchaser profile from any one of the list engine and, or purchase engine by the weight index generator;
apply a learned raw score as a function for each weighted individual criteria to generate a weighted criteria score for each individual criteria, and aggregating said criteria scores to generate a confidence score for each impending transaction by the confidence score generator;
parse a threshold-above confidence score for each impending transaction for threshold-above weighted criteria score and any one of a threshold-above raw score indicating a positive key performance indicator (KPI) and, or a threshold-below raw score indicating a negative KPI by the validation matrix, and wherein said validation matrix dynamically suggests any number or any type of validation check-points for each impending transaction based on at least one of the threshold-grade confidence score, positive KPI, and, or negative KPI.

2. The system of claim 1, wherein a validation pathway depending on any one of, threshold-grade confidence score, positive KPI or negative KPI defines a validation checkpoint to be any one of, neutrally weighed, completely bypassed, rigorously scrutinized, negligently scrutinized or manually included.

3. The system of claim 1, wherein, the learning of the weighted scores and raw values is at least one of, machine learning, fuzzy techniques, neural network techniques or any other probabilistic method.

4. The system of claim 1, wherein the validation check-points are at least one of the following: listing pictures, clean title and documents, property inspection, financial background and status of the purchaser/lister, amenities, cost of living, crime rate, education, employment opportunities, age of property, builder reputation, builder reviews, weather, current and historical market value of property, accessibility and proximity of amenities and public transport, retirement facilities and median income based on area.

5. The system of claim 1, further comprising a matching module, wherein said matching module:
tags any one of, or combination of, a listing, social and, or economic attributes from a list, lister profile, purchaser criteria, and purchaser profile;
match a purchaser to a lister by a matching module applying a matching rule, wherein said match, correlates at least one tagged attribute from the list and lister profile to a tagged attribute from the purchaser criteria and purchaser profile; and
match purchaser and lister with a highest matching score as per the matching rule.

6. The system of claim 5, wherein the matching modules matches lister with the purchaser based on a pre-qualification determination of financing of the purchaser.

7. The system of claim 5, wherein the matching module matches a plurality of purchasers with a lister based on a ranking of a highest confidence score.

8. The system of claim 5, wherein the matching module gives a highest weighted average to a user rating of any one of the purchaser and the lister.

9. The system of claim 1, further comprising a payment module, wherein said payment module:
triggers transfer of at least a partial amount of the contract amount into an intermediary account by said payment module, wherein satisfaction of a contract obligation based on a verification agent causes disbursal of at least a partial amount of the contract amount from the intermediary account to a lister account.

10. The system of claim 9, wherein a confirmation of purchase triggers transfer of at least a partial contract amount from a purchaser payment agent into the lister payment agent by a payment module.

11. The system of claim 9, wherein the transfer of the at least partial contract amount from a purchaser payment agent into the lister payment agent is intervened by an intermediary account.

12. The system of claim 9, wherein the at least partial contract amount is disbursed from the intermediary account upon a validation and, or fulfillment event.

13. The system of claim 9, wherein dissatisfaction of a contract obligation based on a verification agent freezes the disbursal of the contract amount from the intermediary account to the lister account.

14. The system of claim 1, further comprising a tagging module tags attributes from any one of the list engine and, or purchase engine that correlate with attributes listed in a pre-defined and, or intelligently updated library of attributes.

15. The system of claim 14, wherein the tagging module tags attributes from any one of the list engine and, or purchase engine based on a tagging rule, wherein said rule tags attributes based on a threshold-dependent textual or word proximity of any pre-defined social, economic, location, place of origin, other owned properties, preferred real property market and, or other real property references.

16. The system of claim 1, further comprising a profile module that creates any one of the lister profile, listings, purchasing criteria, and the purchaser profile based on a user input, further comprising of any one of a questionnaire-led text input, user-volunteered text input, video input, photograph input, social-media feed, search query, scrolled items, clicked items, home address, geo-location, place of origin, other owned properties, preferred real property market and, or other real property references.

17. The system of claim 1, further comprising a rating system, wherein said rating system rates any one of a user based on at least one of a time of completion, quality of property review, and, or number of transaction.

18. The system of claim 1, further comprising delivery, over a network, of at least one of ancillary legal services, including securing of the title and, or closing escrow upon the satisfaction of the dynamic set of validation checkpoints and contract obligations.

19. A system for generating a dynamic set of validation check-points for real property transactions based on a parsed score, said system comprising a processor, a storage element coupled to the processor, encoded instructions, wherein the system is configured to:
assign a learned weight score to at least one individual criteria;
apply a learned score as a function for each weighted individual criteria to generate a criteria score;
match a purchaser/lister based on the homologous criteria score via the matching module;
aggregate the criteria score to generate a confidence score for a given transaction;
parse a threshold-above confidence score for any one of a positive indicator and, or threshold-below confidence score for any negative indicator for each impending transaction; and
further cause the set of validation checkpoints to adapt, reflecting at least one of the positive indicator and, or negative indicator parsed from the threshold-above confidence score.

20. A method for generating a dynamic set of validation check-points for real property transactions, said method comprising the steps of:
assigning a learned weight score to at least one individual criteria from at least one of a matched listed property, matched lister profile, and, or matched purchaser profile from any one of a list engine and, or a purchase engine by a weight index generator;
applying a learned raw score as a function for each weighted individual criteria to generate a weighted criteria score for each individual criteria, and aggregating said criteria scores to generate a confidence score for each impending transaction by a confidence score generator; and
parsing a threshold-above confidence score for each impending transaction for threshold-above weighted criteria score and any one of a threshold-above raw score indicating a positive key performance indicator (KPI) and, or a threshold-below raw score indicating a negative KPI by a validation matrix, and wherein said validation matrix suggests any number or any type of validation check-points for each impending transaction based on at least one of the threshold-grade confidence score, positive KPI, and, or negative KPI.
